(19) United States
(12) Patent Application Publication
(10) Pub. No.: US 2015/0131026 A1
(43) Pub. Date: May 14, 2015

(54) FLAT PANEL DISPLAY

(71) Applicants: Ching-Hung Chen, Hsin-Chu (TW); Wen-Pin Yang, Hsin-Chu (TW); Chien-Tsai Chueh, Hsin-Chu (TW); Jun-Ho Chen, Hsin-Chu (TW); Ching-Tai Tseng, Hsin-Chu (TW)

(72) Inventors: Ching-Hung Chen, Hsin-Chu (TW); Wen-Pin Yang, Hsin-Chu (TW); Chien-Tsai Chueh, Hsin-Chu (TW); Jun-Ho Chen, Hsin-Chu (TW); Ching-Tai Tseng, Hsin-Chu (TW)

(73) Assignee: Young Lighting Technology Inc., Hsin-Chu (TW)

(21) Appl. No.: 14/514,392

(22) Filed: Oct. 15, 2014

(30) Foreign Application Priority Data
Nov. 11, 2013 (TW) 102221073
Mar. 25, 2014 (TW) 103205107

(51) Int. Cl. G02F 1/1333; G02F 1/1335

(52) U.S. Cl. CPC G02F 1/133308; G02F 1/1336; G02F 1/133382; G02F 2001/133314
USPC 349/60; 349/58

(57) ABSTRACT

A flat panel display includes a plastic rear cover, a supporting frame, a liquid crystal display (LCD) module, a light bar and a front cover. The plastic rear cover constructs a rear half portion of an appearance of the flat panel display. The supporting frame is connected to the plastic rear cover. The LCD module is connected to the supporting frame. The light bar is disposed aside the LCD module. The front cover is connected to the plastic rear cover, constructs a front half portion of the appearance of the flat panel display, and has an opening to expose the LCD module.

### CROSS-REFERENCE TO RELATED APPLICATION

This application claims the priority benefits of Taiwan application serial no. 102221073, filed on Nov. 11, 2013, and Taiwan application serial no. 103205107, filed on Mar. 25, 2014. The entirety of each of the above-mentioned patent applications is hereby incorporated by reference herein and made a part of this specification.

### BACKGROUND OF THE INVENTION

1. Field of the Invention

The invention relates to a flat panel display; more particularly, to a flat panel display for displaying images.

2. Description of Related Art

With rapid progress in display techniques, flat panel displays have become a mainstream of displays. Among various displays, liquid crystal displays (LCDs) have been deeply favored by consumers.

As for manufacturing LCDs, LCD modules and backlight modules are installed between front covers and rear covers, and LCD modules are exposed through openings of front covers, while both front covers and rear covers compose product appearances of LCDs.

In order to provide sufficient structural strength, a material of rear covers is usually metal, such as electro-galvanized steel sheets (SECC) or aluminum alloys. However, although metallic rear covers provide sufficient structural strength, LCDs weight more and cost more. If a plastic material is used for rear covers, plastic rear covers having the same thickness as metallic rear covers do not provide sufficient strength. Thicker plastic rear covers are required for providing the same level of strength, but an overall thickness of displays is increased. In addition, when a plastic material is compared to a metallic material, heat diffusion effects of a plastic material is poorer and heat generated from insides of displays cannot be diffused effectively. When sizes of the displays become bigger, demands for heat dissipation and overall strength also are increased. A conventional single material used for manufacturing the displays may not meet these two demands at the same time.

China Patent Publication No. CN102096219, China Patent Publication No. CN101685209, Taiwan Patent Publication No. 200944889 and Taiwan Patent Publication No. 201245821 disclose techniques applied on housings of LCDs.

### SUMMARY OF THE INVENTION

The invention is directed to a flat panel display having advantages of lightness and low costs.

Other objects and advantages of the invention may be further understood with the technical features disclosed in the invention.

In order to achieve at least one of the objects or other objects, one embodiment of the invention is directed to a flat panel display including a plastic rear cover, a supporting frame, a liquid crystal display (LCD) module, a light bar and a front cover. The plastic rear cover constructs a rear half portion of an appearance of the flat panel display. The supporting frame is connected to the plastic rear cover. The LCD module is connected to the supporting frame. The light bar is disposed aside the LCD module. The front cover is connected to the plastic rear cover, constructs a front half portion of the appearance of the flat panel display, and has an opening to expose the LCD module.

The flat panel display according to an embodiment of the invention includes a supporting frame, wherein the supporting frame includes a bonding face, a plurality of horizontal ribs and a plurality of vertical ribs. The light bar is connected to the bonding face. The horizontal ribs are arranged on the plastic rear cover, while the vertical ribs are arranged on the plastic rear cover.

A material of the horizontal ribs of the flat panel display according to an embodiment of the invention is metal.

The horizontal ribs of the flat panel display according to an embodiment of the invention have bending structures.

A material of the vertical ribs of the flat panel display according to an embodiment of the invention is metal.

The vertical ribs of the flat panel display according to an embodiment of the invention have bending structures.

The vertical ribs of the flat panel display of an embodiment of the invention are provided with a plurality of mounting holes, and the mounting holes are in compliance with the video electronics standards association (VESA) specification.

An LCD module included in a flat panel display according to an embodiment of the invention further includes an LCD panel, a light guide plate (LGP), a reflective layer and a plurality of optical films. The light guide plate is disposed between the supporting frame and the LCD panel. The reflective layer is disposed between the supporting frame and the light guide plate. The optical films are disposed between the LCD panel and the light guide plate.

The flat panel display according to an embodiment of the invention further includes a positioning frame disposed between the plastic rear cover and the front cover, and positioning the LCD panel and the optical films.

A light bar included in the flat panel display according to an embodiment of the invention is disposed aside a light incident surface of the light guide plate. The light bar is suitable for emitting a light beam, wherein the light beam enters the light guide plate from the light incident surface, and the light bar includes a plurality of point light sources arranged along an arranging direction.

The flat panel display according to an embodiment of the invention has a peripheral wall of the plastic rear cover locked with a peripheral wall of the front cover, and an external surface of the plastic rear cover is even with an external surface of the front cover.

A material of the front cover of the flat panel display according to an embodiment of the invention is plastic.

An LCD module of the flat panel display according to an embodiment of the invention further includes an LCD panel and a plurality of optical films. The optical films are disposed between the supporting frame and the LCD panel, wherein the light bar is disposed between the optical films and the supporting frame.

The flat panel display according to an embodiment of the invention includes a supporting frame, wherein the supporting frame includes a plurality of horizontal ribs, a plurality of vertical ribs, and a heat dissipation plate. The horizontal ribs are arranged on the plastic rear cover. The vertical ribs are arranged on the plastic rear cover. The heat dissipation plate has a first plane section and a second plane section extending from the first plane section and inclining corresponding to the first plane section. The first plane section is connected to the light bar, and the second plane section is disposed horizontally on the plastic rear cover.

The flat panel display according to an embodiment of the invention includes a heat dissipation plate, wherein the second plane section of the heat dissipation plate and the horizontal ribs are overlapped with each other and fastened with each other on a normal direction of the second plane section.

The flat panel display according to an embodiment of the invention includes a heat dissipation plate, wherein the second plane section of the heat dissipation plate and the vertical ribs are overlapped with each other and fastened with each other on a normal direction of the second plane section.

The flat panel display according to an embodiment of the invention includes a heat dissipation plate, wherein the second plane section of the heat dissipation plate and the horizontal ribs are not overlapped with each other on a normal direction of the second plane section.

The flat panel display according to an embodiment of the invention includes a heat dissipation plate, wherein the second plane section of the heat dissipation plate and the vertical ribs are not overlapped with each other on a normal direction of the second plane section.

Materials of the horizontal ribs and the vertical ribs of the plat panel display according to an embodiment of the invention include iron.

The horizontal ribs and the vertical ribs of the plat panel display according to an embodiment of the invention are galvanized steel plates.

A material of the heat dissipation plate of the flat panel display according to an embodiment of the invention is aluminum.

The flat panel display according to an embodiment of the invention includes a heat dissipation plate, wherein a heat conductivity of a material of the heat dissipation plate is greater than heat conductivities of materials of the horizontal ribs and the vertical ribs, and a structural strength of the material of the heat dissipation plate is weaker than structural strength of the materials of the horizontal ribs and the vertical ribs.

Each of the vertical ribs of the flat panel display according to an embodiment of the invention has a bending structure.

Each of horizontal ribs of the flat panel display according to an embodiment of the invention has a bending structure.

A plastic rear cover of the flat panel display in an embodiment of the invention has a plurality of ribs, and the ribs protrude from the plastic rear cover.

An included angle between the first plane section and the second plane section of the flat panel display in an embodiment of the invention is 90 degrees.

In view of the foregoing, the above embodiments of the invention may achieve at least one of the following advantages or effects.

In the above embodiments of the invention, in comparisons with the conventional metal rear cover having heavier weights and higher costs, a match of the plastic rear cover and the supporting frame not only achieves an object of light weight but also meets demands of low costs and thinness.

In another embodiment of the invention, when a screen of a flat panel display is bigger, a supporting frame may further include a heat dissipation plate. The heat dissipation plate may be connected to a light bar to provide excellent dissipation effects. Furthermore, the heat dissipation plate may be deemed as an auxiliary to provide structural strength, and achieve better dissipation effects and stronger structural strength at the same time. Moreover, the heat dissipation plate may solve an issue of higher costs for one single material.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a front view illustrating a flat panel display according to an embodiment of the invention.

FIG. 2 is a front view illustrating a plastic rear cover and a supporting frame of the flat panel display depicted in FIG. 1.

FIG. 3 is an enlarged cross-sectional view illustrating the flat panel display depicted in FIG. 1 along a line I-I.

FIG. 4 is an enlarged view illustrating a lower end of the flat panel display depicted in FIG. 3.

FIG. 5 is an enlarged view illustrating an upper end of the flat panel display depicted in FIG. 3.

FIG. 6 is a partial cross-sectional view illustrating a flat panel display according to another embodiment of the invention.

FIG. 7 is a front view illustrating a plastic rear cover and a supporting frame of a flat panel display according to another embodiment of the invention.

FIG. 8 is an enlarged cross-sectional view illustrating the plastic rear cover and the supporting frame of the flat panel display depicted in FIG. 7 along a line II-II.

FIG. 9 is an enlarged view illustrating a lower end of the plastic rear cover and the supporting frame of the flat panel display depicted in FIG. 8.

FIG. 10 is a front view illustrating a plastic rear cover and a supporting frame of a flat panel display according to another embodiment of the invention.

FIG. 11 is an enlarged cross-sectional view illustrating the plastic rear cover and the supporting frame of the flat panel display depicted in FIG. 10 along a line III-III.

FIG. 12 is an enlarged view illustrating a lower end of the plastic rear cover and the supporting frame of the flat panel display depicted in FIG. 11.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

With reference to FIG. 1 to FIG. 4, a flat panel display 100 of the embodiment is not only deemed as a computer peripheral display, but also could be applied in a television set. The flat panel display 100 includes a plastic rear cover 110, a supporting frame 120, a liquid crystal display (LCD) module 130, a light bar 140 and a front cover 150. The plastic rear cover 110 is a cover made of a plastic material and directly constructs a rear half portion of an appearance of the plat panel display 100, and therefore achieves lightness and low costs. The supporting frame 120 is connected to the plastic rear cover 110 and has a bonding face 120a. The LCD module 130 is connected to the supporting frame 120. The light bar 140 is disposed aside the LCD module 130 and is connected to the bonding face 120a of the supporting frame 120. A material of the front cover 150 is plastic, and the front cover 150 is connected to the plastic rear cover 110 so as to construct a front half portion of the appearance of the flat panel display 100. The front cover 150 further has an opening 152 to expose the LCD module 130.

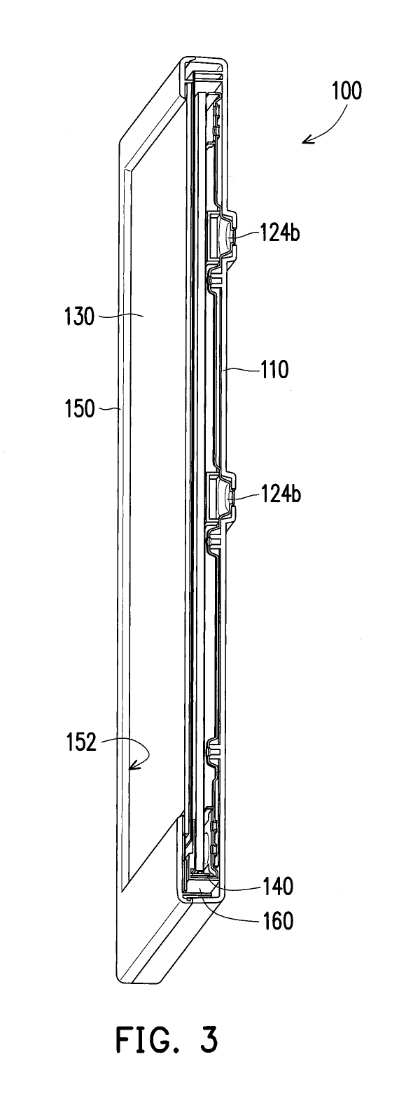

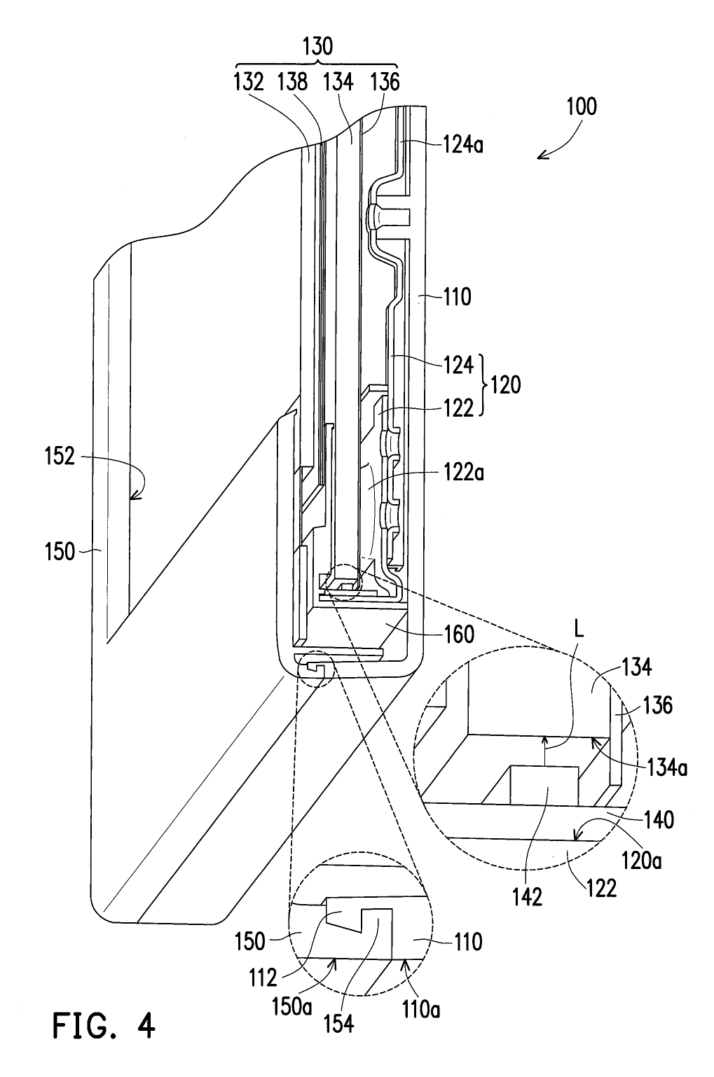

With reference to FIG. 3 and FIG. 4, the LCD module 130 of the embodiment further includes a liquid crystal display (LCD) panel 132, a light guide plate (LGP) 134, a reflective layer 136 and a plurality of optical films 138. The light guide plate 134 is disposed between the supporting frame 120 and the LCD panel 132. The reflective layer 136 is disposed between the supporting frame 120 and the light guide plate 134. These optical films 138 are disposed between the LCD panel 132 and the light guide plate 134. In addition, the flat panel display 100 further includes a positioning frame 160 disposed between the plastic rear cover 110 and the front cover 150, and positioning the LCD panel 132 and these optical films 138. Furthermore, the light bar 140 is disposed aside a light incident surface 134a of the light guide plate 134. The light bar 140 is suitable for emitting a light beam L, wherein the light beam L enters the light guide plate 134 from the light incidence surface 134a. Besides, the light bar 140 includes a plurality of point light sources 142 (e.g., light emitting diode (LED) elements) arranged along an arranging direction.

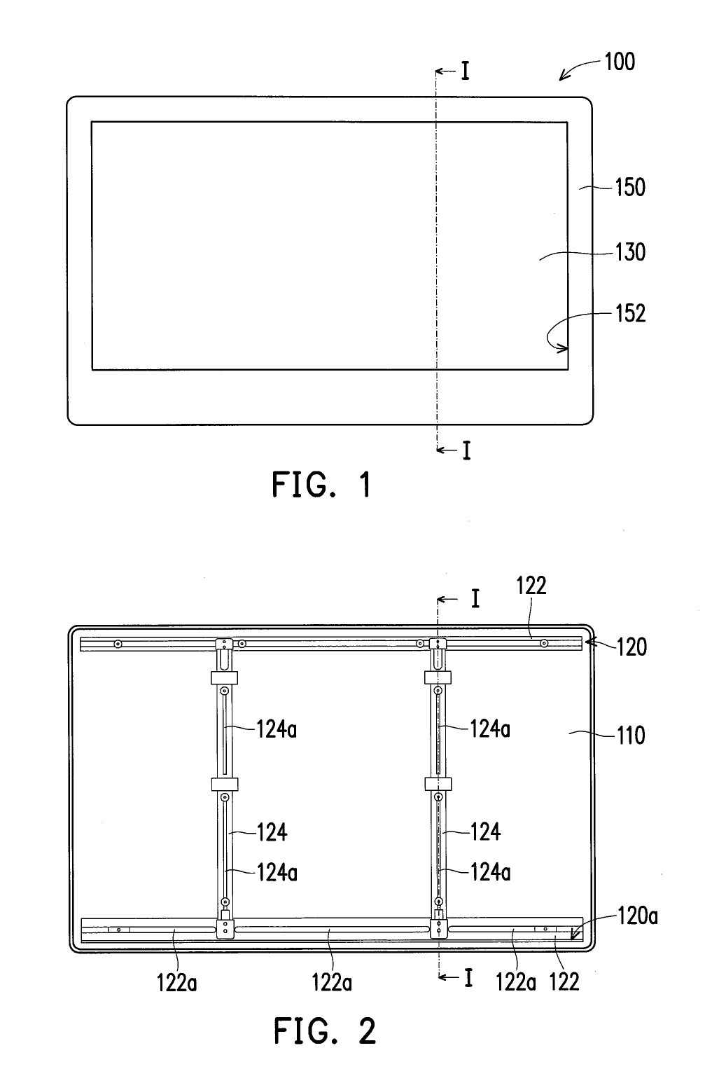

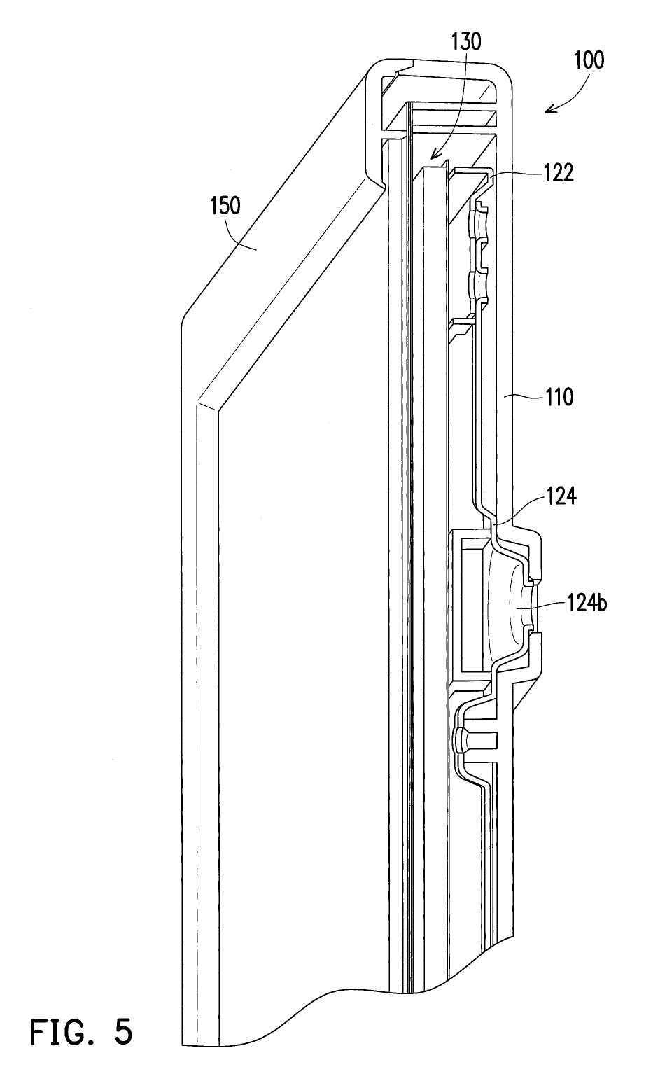

With reference to FIG. 2, FIG. 3 and FIG. 5, the supporting frame 120 of the embodiment includes a plurality of horizontal ribs 122 and a plurality of vertical ribs 124. These horizontal ribs 122 are horizontally arranged on the plastic rear cover 110, while these vertical ribs 124 are vertically arranged on the plastic rear cover 110. In order to provide good structural strength, these horizontal ribs 122 are formed of a metal material and have bending structures 122a, while these vertical ribs 124 are also formed of a metal material and have bending structures 124a. It should be noted that the horizontal ribs 122 disposed down below further constructs the bonding face 120a of the supporting frame 120, so as to be connected to the light bar 140, as shown in FIG. 4. When the material of the horizontal ribs 122 is metal, heat generated from luminescence of the light bar 140 may be transmitted to other parts of the horizontal ribs 122 through the bonding faces 120a constructed by the horizontal ribs 122, and further being transmitted to these vertical ribs 124 through contacts between the horizontal ribs 122 and the vertical ribs 124. It should be noted that quantities of the horizontal ribs 122 and the vertical ribs 124 of the invention may be adjusted based on demands of intensity of the flat panel display 100. Accordingly, the supporting frame 120 may include one or more horizontal ribs 122 and vertical ribs 124, but the invention is not limited herein. In addition, each of the vertical ribs 124 is provided with a plurality of mounting holes 124b, and these mounting holes 124b are in compliance with the video electronics standards association (VESA) specification, i.e., the corresponding common specification for commercial hanging racks of displays.

With reference to FIG. 4, a peripheral wall of the plastic rear cover 110 of embodiment is locked with a peripheral wall of the front cover 150. Specifically, a plurality of rear locking parts 112 are formed on the peripheral wall of the plastic rear cover 110, while a plurality of front locking parts 154 are also formed on the peripheral wall of the front cover 150 and configured to lock respectively with these rear locking parts 112. Further, an external surface 110a of the plastic rear cover 110 is even with an external surface 150a of the front cover 150. Consequently, the plastic rear cover 110 and the front cover 150 together construct a product appearance of the flat panel display 100; particularly product appearances of front, rear and peripheral side of the flat panel display 100.

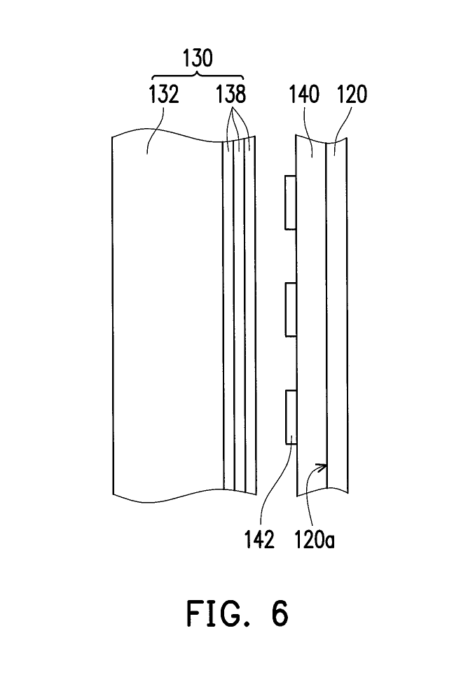

With reference to FIG. 3 and FIG. 4, in the aforesaid embodiment, an edge-lit type backlight source is adopted. Namely, the light beam L emitted from the light bar 140 enters the light guide plate 134 from the light incident surface 134a located at a side of the light guide plate 134. However, in another embodiment, as shown in FIG. 6, the LCD module 130 includes the LCD panel 132 and the plurality of optical films 138. These optical films 138 are disposed between the supporting frame 120 and the LCD panel 132, while the light bar 140 is disposed between the optical films 138 and the supporting frame 120. In other words, according to the embodiment shown in FIG. 6, the light bar 140 is deemed as a direct-lit type backlight source.

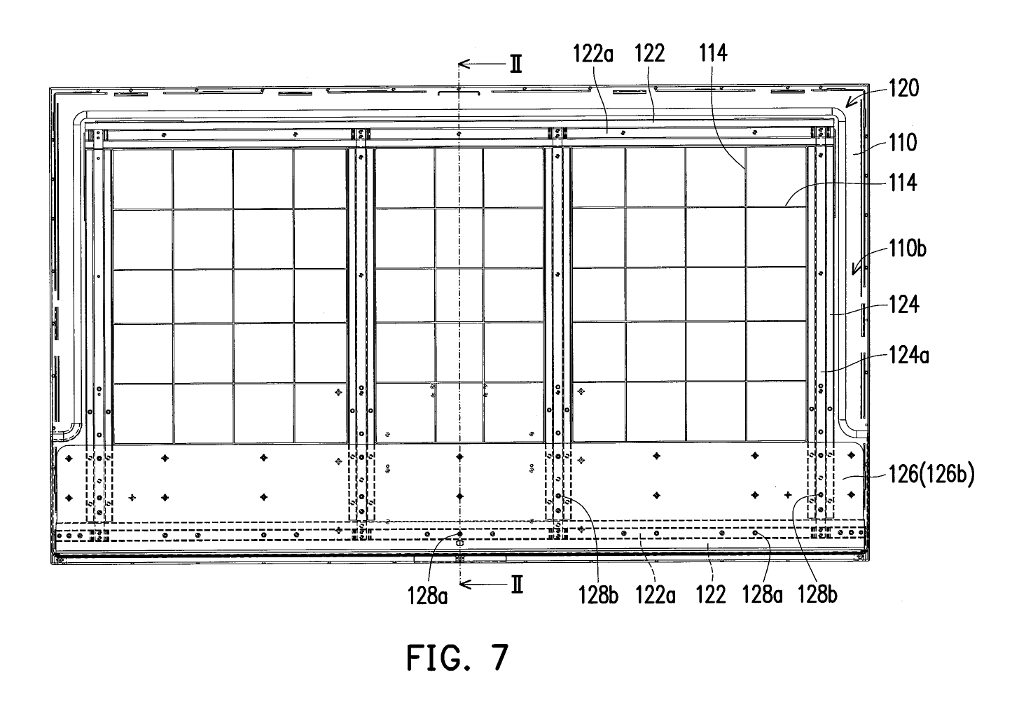

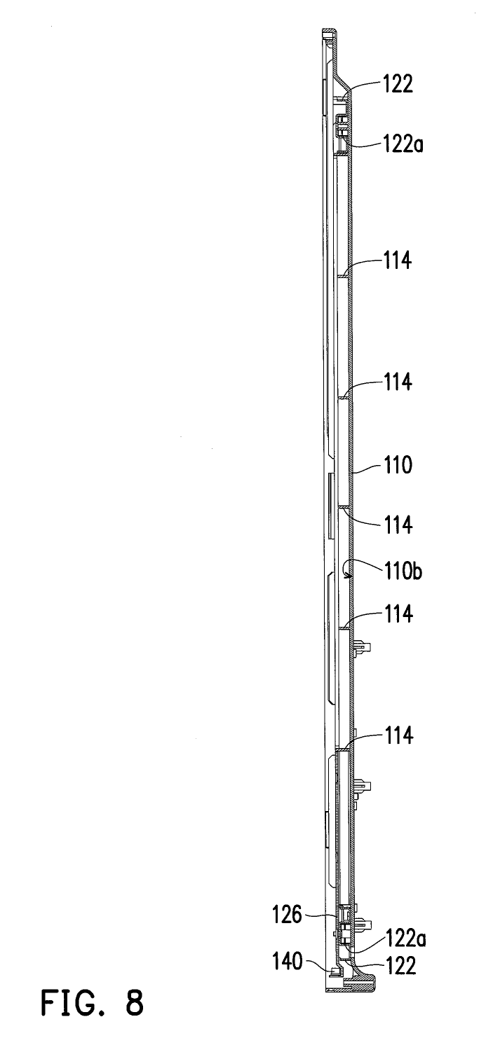

With reference to FIG. 7 to FIG. 9, the embodiment illustrating FIG. 7 to FIG. 9 is different from the embodiments illustrating FIG. 2 to FIG. 4, as the supporting frame 120 of the embodiment further includes a heat dissipation plate 126. The heat dissipation plate 126 has a first plane section 126a and a second plane section 126b. The first plane section 126a is connected to the light bar 140. The second plane section 126b extends from the first plane section 126a and inclines corresponding to the first plane section 126a, and is disposed horizontally on the plastic rear cover 110. In the embodiment, an included angle A between the first plane section 126a and the second plane section 126b may be 90 degrees.

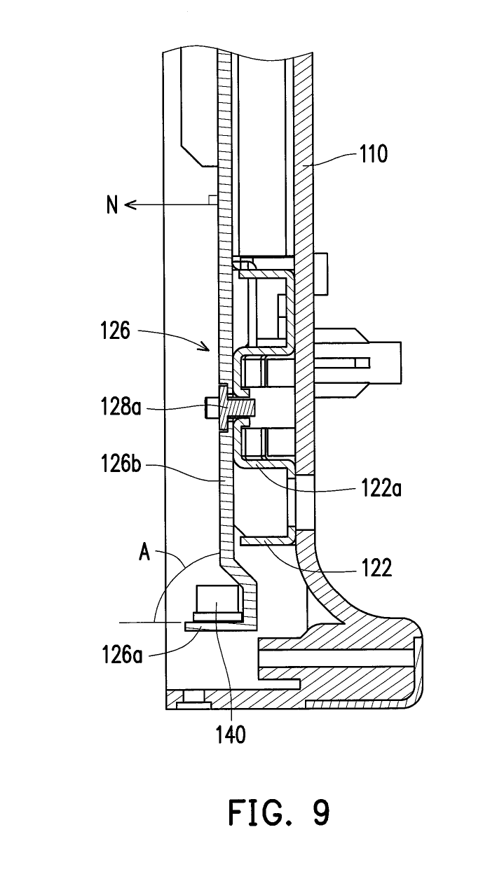

The second plane section 126b of the heat dissipation plate 126 and the horizontal rib 122 are overlapped with each other and fastened with each other on a normal direction N of the second plane section 126b. Specifically, as shown in FIG. 7 and FIG. 9, when the second plane section 126b of the heat dissipation plate 126 and the horizontal rib 122 are fastened with each other through a plurality of fasteners 128a (i.e., metal screws), heat dissipated from the heat dissipation plate 126 may be transmitted to the horizontal rib 122 through the fasteners 128a, so as to increase a heat dissipation area.

In addition, the second plane section 126b of the heat dissipation plate 126 and the vertical ribs 124 are overlapped with each other and fastened with each other on the normal direction N of the second plane section 126b. Specifically, as shown in FIG. 7, when the second plane section 126b of the heat dissipation plate 126 and the vertical ribs 124 are fastened with each other through a plurality of fasteners 128b (i.e., metal screws), heat dissipated from the heat dissipation plate 126 may be transmitted to the vertical ribs 124 through the fasteners 128b, so as to increase a heat dissipation area.

With reference to FIG. 7 again, a heat conductivity of a material of the heat dissipation plate 126 may be greater than heat conductivities of materials of the horizontal ribs 122 and the vertical ribs 124, and a structural strength of the material of the heat dissipation plate 126 may be weaker than structural strength of the materials of the horizontal ribs 122 and the vertical ribs 124. In the embodiment, the materials of the horizontal ribs 122 and the vertical ribs 124 may be iron, or the horizontal ribs 122 and the vertical ribs 124 may be galvanized steel plates, while the material of the heat dissipation plate 126 may be aluminum.

The horizontal ribs 122 may have a bending structure 122a, while the vertical ribs 124 may have a bending structure 124a. Furthermore, the plastic rear cover 110 may further include a plurality of ribs 114. The ribs 114 protrude from the plastic rear cover 110, particularly from an inner surface 110b of the plastic rear cover 110. The ribs 114 may be distributed in portions of the plastic rear cover 110 where structural strength for the portions needs to be enhanced.

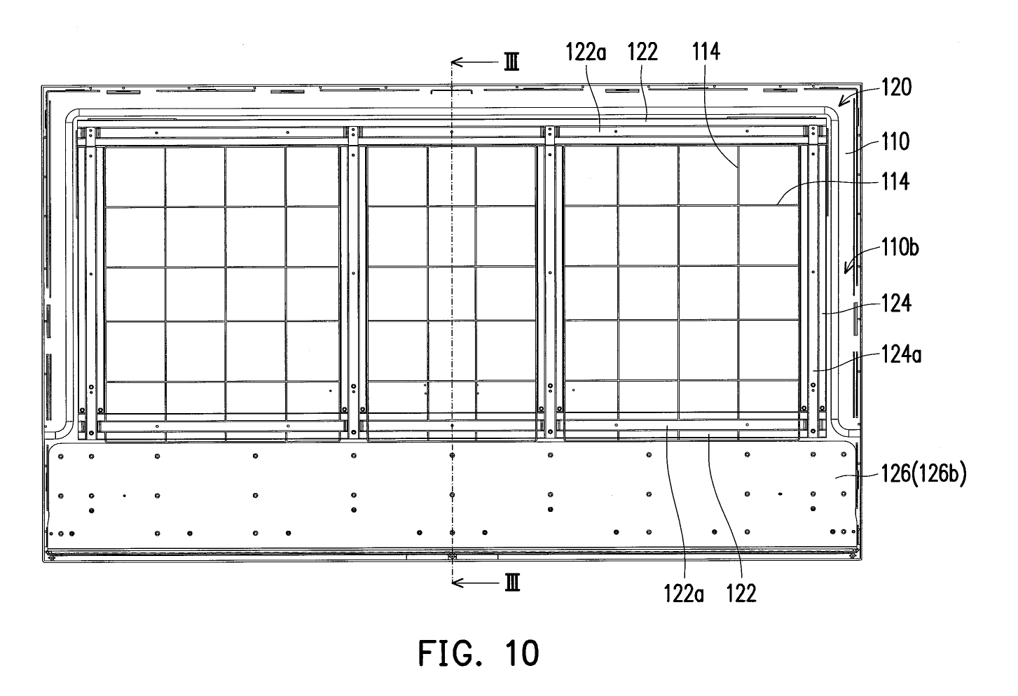

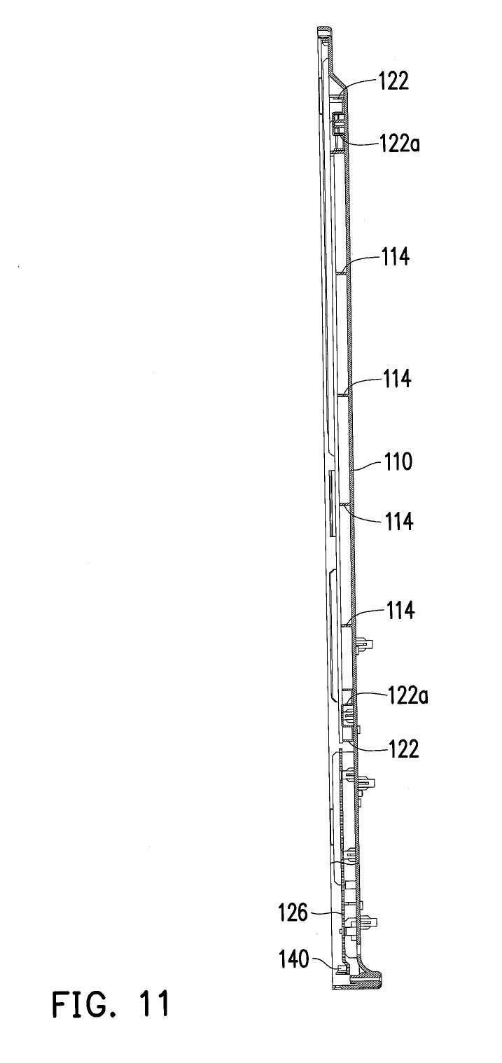

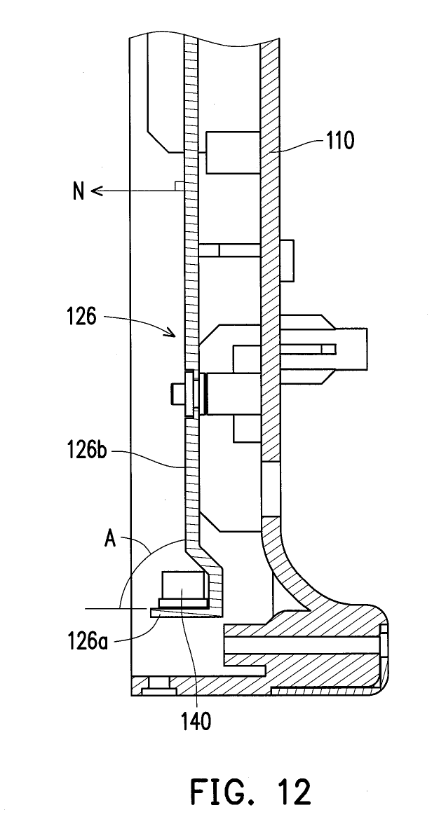

With reference to FIG. 10 to FIG. 12, the embodiment illustrating FIG. 10 to FIG. 12 is different from the embodiment illustrating FIG. 7 to FIG. 9, as the second plane section 126b of the heat dissipation plate 126 and the horizontal ribs 122 are not overlapped with each other on the normal direction N of the second plane section 126b. The second plane section 126b of the heat dissipation plate 126 and the vertical ribs 124 are not overlapped with each other on the normal direction N of the second plane section 126b. In brief, as shown in FIG. 10, the horizontal ribs 122 and the second plane section 126b of the heat dissipation plate 126 are not overlapped with each other, and are located at one side of the second plane section 126b of the heat dissipation plate 126. Moreover, the vertical ribs 124 only extend to one edge of the second plane section 126b of the heat dissipation plate 126 and are not overlapped with the second plane section 126b.

In view of the foregoing, the above embodiments of the invention may achieve at least one of the following advantages or effects. In the above embodiments of the invention, in comparisons with the conventional metal rear cover having heavier weights and higher costs, a match of the plastic rear cover and the supporting frame not only achieves a purpose of light weight but also meets demands of low costs and thinness. In addition, in the above embodiment of the invention, a plurality of mounting holes in compliance with the VESA specification may be directly manufactured on these vertical ribs of the supporting frame, and therefore may be directly installed to commercial hanging racks of displays complying with common specification. Additionally, in the above embodiments of the invention, when a screen of a flat panel display is bigger, a supporting frame may further include a heat dissipation plate. The heat dissipation plate may be connected to a light bar to provide excellent heat dissipation effects. Furthermore, the heat dissipation plate may be deemed as an auxiliary to provide structural strength, and achieve better heat dissipation effects and stronger structural strength at the same time. Moreover, the heat dissipation plate may solve an issue of higher costs for one single material. For a flat panel display having high luminance and a large size, a heat dissipation plate may provide more favorable heat dissipation effects.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A flat panel display, comprising:
a plastic rear cover constructing a rear half portion of an appearance of the flat panel display;
a supporting frame connected to the plastic rear cover;
a liquid crystal display (LCD) module connected to the supporting frame;
a light bar disposed aside the LCD module; and
a front cover connected to the plastic rear cover, constructing a front half portion of the appearance of the flat panel display, and having an opening to expose the LCD module.

2. The flat panel display as claimed in claim 1, wherein the supporting frame comprises:
a bonding face, wherein the light bar is connected to the bonding face;
a plurality of horizontal ribs arranged on the plastic rear cover; and
a plurality of vertical ribs arranged on the plastic rear cover.

3. The flat panel display as claimed in claim 2, wherein a material of the horizontal ribs is metal.

4. The flat panel display as claimed in claim 2, wherein each of the horizontal ribs has a bending structure.

5. The flat panel display as claimed in claim 2, wherein a material of the vertical ribs is metal.

6. The flat panel display as claimed in claim 2, wherein each of the vertical ribs has a bending structure.

7. The flat panel display as claimed in claim 2, wherein the vertical ribs are provided with a plurality of mounting holes, and the mounting holes are in compliance with the video electronics standards association (VESA) specification.

8. The flat panel display as claimed in claim 1, wherein the LCD module further comprises:
an LCD panel;
a light guide plate (LGP) disposed between the supporting frame and the LCD panel;
a reflective layer disposed between the supporting frame and the light guide plate; and
a plurality of optical films disposed between the LCD panel and the light guide plate.

9. The flat panel display as claimed in claim 8, further comprising:
a positioning frame disposed between the plastic rear cover and the front cover, and positioning the LCD panel and the optical films.

10. The flat panel display as claimed in claim 8, wherein the light bar is disposed aside a light incident surface of the light guide plate, the light bar is suitable for emitting a light beam, wherein the light beam enters the light guide plate from the light incident surface, and the light bar includes a plurality of point light sources arranged along an arranging direction.

11. The flat panel display as claimed in claim 1, wherein a peripheral wall of the plastic rear cover is locked with a peripheral wall of the front cover, and an external surface of the plastic rear cover is even with an external surface of the front cover.

12. The flat panel display as claimed in claim 1, wherein a material of the front cover is plastic.

13. The flat panel display as claimed in claim 1, wherein the LCD module further comprises:
an LCD panel; and
a plurality of optical films disposed between the supporting frame and the LCD panel, wherein the light bar is disposed between the optical films and the supporting frame.

14. The flat panel display as claimed in claim 1, wherein the supporting frame comprises:
a plurality of horizontal ribs arranged on the plastic rear cover;
a plurality of vertical ribs arranged on the plastic rear cover; and
a heat dissipation plate having a first plane section and a second plane section extending from the first plane section and inclining corresponding to the first plane section, the first plane section connected to the light bar, the second plane section disposed horizontally on the plastic rear cover.

15. The flat panel display as claimed in claim 14, wherein the second plane section of the heat dissipation plate and the at least one of the horizontal ribs are overlapped with each other and fastened with each other on a normal direction of the second plane section.

16. The flat panel display as claimed in claim 14, wherein the second plane section of the heat dissipation plate and the vertical ribs are overlapped with each other and fastened with each other on a normal direction of the second plane section.

17. The flat panel display as claimed in claim 14, wherein the second plane section of the heat dissipation plate and the horizontal ribs are not overlapped with each other on a normal direction of the second plane section.

18. The flat panel display as claimed in claim 14, wherein the second plane section of the heat dissipation plate and the vertical ribs are not overlapped with each other on a normal direction of the second plane section.

19. The flat panel display as claimed in claim 14, wherein materials of the horizontal ribs and the vertical ribs comprise iron.

20. The flat panel display as claimed in claim 14, wherein the horizontal ribs and the vertical ribs are galvanized steel plates.

21. The flat panel display as claimed in claim 14, wherein a material of the heat dissipation plate is aluminum.

22. The flat panel display as claimed in claim 14, wherein a heat conductivity of a material of the heat dissipation plate is greater than heat conductivities of materials of the horizontal ribs and the vertical ribs, and a structural strength of the material of the heat dissipation plate is weaker than structural strength of the materials of the horizontal ribs and the vertical ribs.

23. The flat panel display as claimed in claim 14, wherein each of the vertical ribs has a bending structure.

24. The flat panel display as claimed in claim 14, wherein each of the horizontal ribs has a bending structure.

25. The flat panel display as claimed in claim 14, wherein the plastic rear cover has a plurality of ribs, and the ribs protrude from the plastic rear cover.

26. The flat panel display as claimed in claim 14, wherein an included angle between the first plane section and the second section is 90 degrees.
